(19) United States
(12) Patent Application Publication
(10) Pub. No.: US 2007/0135549 A1
(43) Pub. Date: Jun. 14, 2007

(54) ABS moulding materials containing special metal compounds

(75) Inventor: Herbert Eichenauer, Dormagen (DE)

Correspondence Address: LANXESS CORPORATION, 111 RIDC PARK WEST DRIVE, PITTSBURGH, PA, 15275-1112, US

(73) Assignee: LANXESS Deutschland GmbH

(21) Appl. No.: 11/633,798

(22) Filed: Dec. 5, 2006

(30) Foreign Application Priority Data
Dec. 8, 2005 (DE) 10 2005 058 510.8

(51) Int. Cl. C08K 3/10

(52) U.S. Cl. 524/403; 524/513

(57) ABSTRACT

ABS moulding materials containing an addition of at least one compound of the lanthanides, process for the preparation of the moulding materials and a method for identifying ABS moulding materials.

The invention relates to ABS moulding materials containing special metal oxides and mouldings obtained therefrom by injection moulding, or extrusion or by other processing methods.

ABS moulding materials are two-phase plastics comprising
1.) a thermoplastic copolymer of styrene and acrylonitrile, in which the styrene can be completely or partly replaced by α-methylstyrene or methyl methacrylate; this copolymer, also referred to as SAN resin or matrix resin, forms the outer phase, and
2.) at least one graft polymer which has been prepared by a grafting reaction of one or more of those monomers mentioned under 1. on butadiene homo- or copolymer (“grafting base”). This graft polymer (“elastomer phase” or “graft rubber”) forms the disperse phase in the matrix resin.

The polymers mentioned under 1. and 2. and their mixture are known, as are processes for their preparation (e.g. emulsion, solution, mass, suspension or precipitation polymerization or combinations).

In the preparation of ABS moulding materials from the abovementioned building blocks 1. and 2., a fundamental problem is subsequently to obtain information about the components used from the moulding materials (e.g. information about the origin of the polymer components used, as, for example, with the use of building blocks from different production plants or different production locations) or to trace back the origin thereof.

Although it is possible in principle to obtain information about the original building blocks by adding dyes or other organic components to the polymer building blocks and analysing these substances in the finished product, owing to the large added amounts necessary and the changes in the properties of the polymer material which consequently occur in practice (e.g. occurrence of undesired discolorations or difficult colourability, reduction of the modulus through the plasticizer effect of the added organic compounds, etc.), the addition of such substances has not proved useful.

DE-A 4 408 213 already discloses that the thermal stability of ABS polymer moulding materials can be improved by adding special alkali metal and alkaline earth metal compounds.

DE-A 4 029 167 discloses plastics comprising fluorescent dyes for the sorting of wastes.

The use of rare earth oxides for the production of ceramic green compacts having high strengths for improving the mechanical processability is disclosed in DE-A 3 737 638. WO 01/34196 A2 discloses the addition of thulium oxide to plastics which are used in clinical medicine, reference being made to polyethylene, polyamide, polypropylene, polytetrafluoroethylene, polyvinylidene fluoride, Teflon, silicone or PMMA with or without a fibre content, such as carbon fibres or glass fibres, as matrix material.

It was the object of the invention to find a method for subsequently obtaining information about the components used from ABS moulding materials, in particular a method for identifying ABS moulding materials. It was furthermore the object of the invention to provide corresponding ABS moulding materials.

The invention relates to ABS moulding materials containing an addition of at least one compound of the lanthanides.

Here, lanthanides are understood as meaning lanthanum and the fourteen elements following lanthanum. These are also referred to as rare earth metals. Particularly preferred compounds of the lanthanides are the oxides thereof.

ABS moulding materials containing combinations of at least two different metal oxides selected from oxides of the lanthanides are preferred.

Preferred oxides are lanthanum oxide (La₂O₃), cerium oxide (CeO₂), praseodymium oxide (Pr₆O₁₁, Pr₂O₃), neodymium oxide (Nd₂O₃), samarium oxide (Sm₂O₃), gadolinium oxide (Gd₂O₃), dysprosium oxide (Dy₂O₃), erbium oxide (Er₂O₃), ytterbium oxide (Yb2O₃).

Particularly preferred oxides are lanthanum oxide, cerium oxide, praseodymium oxide, gadolinium oxide, dysprosium oxide.

The compounds to be used according to the invention can be used in the form of powders, in the form of nanoparticles, in the form of particles dispersed in water, preferably in the form of dispersed nanoparticles.

The total amount of compounds of the lanthanides which are present in the moulding materials is preferably 0.01 to 1000 ppm, particularly preferably 0.1 to 100 ppm and very particularly preferably 1 to 50 ppm.

The amounts of compounds of the lanthanides which are added to the individual components used in the ABS preparation (graft rubbers, thermoplastic resins) are preferably chosen so that altogether the abovementioned total amounts result. It may be advantageous to add the added amounts in proportion to the amounts of the individual components used.

The ABS moulding materials may be present as such but also as a so-called blend, in particular with polyamide, polycarbonate and/or polybutylene terephthalate. Particularly preferred polyamide blends contain 100 to 250 parts by weight of polyamide per 100 parts by weight of ABS. Furthermore, they are preferably distinguished by good processability and high stability under thermal load.

Particularly preferred polycarbonate blends contain 25 to 400 parts by weight of polycarbonate per 100 parts by weight of ABS. Furthermore, they are preferably distinguished by a combination of high heat distortion resistance and good toughness.

Particularly preferred polybutylene terephthalate blends contain 50 to 500 parts by weight of polybutylene terephthalate per 100 parts by weight of ABS. Furthermore, they are preferably distinguished by good toughness and high resistance to chemicals.

The mixing of the components used for producing the ABS moulding materials with the compounds of the lanthanides can be effected in various ways.

Thus, the mixing with graft rubber components (in the synthesis thereof by emulsion polymerization) can be effected by addition of an aqueous dispersion of the lanthanide compound component to the graft rubber latex and working up together by precipitation and drying.

For incorporating the lanthanide compound component into solids, such as graft rubber powder or granules of resin components, incorporation by compounding on customary compounding units (e.g. screw machines, internal kneaders) has proved useful.

The determination of the compounds of the lanthanides which are present in the ABS moulding materials can be effected by customary analytical methods. The ICP-AES-OES method (inductively coupled plasma with optical emission spectroscopy, cf. e.g. http://icp-oes.com and literature cited there) is particularly suitable since a very high accuracy of detection is achieved.

ICP-AES stands for inductive coupled plasma atomic (optical) emission spectroscopy in English. The method of inductively coupled plasma is based on the use of a very hot (about 10 000 K) argon plasma for inducing the optical emission of the elements to be analysed. The energy transmission takes place after ignition by Tesla arcing through the high-frequency field present in the coils. Free electrons are now accelerated by the field present and heat up the plasma through collision with the atomic cores. Owing to the high particle density in the plasma, plasma and sample aerosol heat up to 6000-10 000 K. The sample aerosol is passed through the middle of the plasma stream without influencing the stability/equilibrium thereof. The most important parts of an ICP spectrometer are high-frequency generator, plasma torch, sample atomizer and the actual spectrometer.

Preferred ABS moulding materials or ABS polymers in the context of the invention contain 5 to 100% by weight, preferably 10 to 80% by weight, of at least one graft polymer and 95 to 0% by weight, preferably 90 to 20% by weight, of at least one thermoplastic copolymer resin.

Graft polymers in the context of the invention are those in which styrene or methyl methacrylate or a mixture of 95 to 50% by weight of styrene, α-methylstyrene, styrene substituted on the nucleus, methyl methacrylate or mixtures thereof and 5 to 50% by weight of acrylonitrile, methacrylonitrile, maleic anhydride, N-substituted maleimides or mixtures thereof are subjected to graft polymerization onto a rubber. Suitable rubbers are virtually all rubbers having glass transition temperatures of ≦10° C., e.g. polybutadiene, styrene-butadiene polymers, acrylonitrile-butadiene polymers, polyisoprene, acrylate rubbers, such as, for example, poly-n-butyl acrylate. The alkyl acrylate rubbers can optionally contain up to 30% by weight (based on the weight of rubber) of monomers such as vinyl acetate, acrylonitrile, styrene, methyl methacrylate and/or vinyl ether incorporated in the form of copolymerized units. The acrylate rubbers can furthermore contain smaller amounts, preferably up to 5% by weight (based on the weight of rubber) of ethylenically unsaturated monomers having a crosslinking effect, incorporated in the form of polymerized units. Such crosslinking agents are, for example, alkylenediol diacrylates and dimethacrylates, polyester diacrylates and dimethacrylates, divinylbenzene, trivinylbenzene, triallyl cyanurate, allyl acrylate and methacrylate, butadiene or isoprene.

The grafting base may also be acrylate rubbers having a core/shell structure, with a core of crosslinked diene rubber comprising one or more conjugated dienes, such as polybutadiene, or a copolymer of a conjugated diene with an ethylenically unsaturated monomer, such as styrene and/or acrylonitrile.

Further suitable rubbers are, for example, the so-called EPDM rubbers (polymers of ethylene, propylene and a nonconjugated diene, such as, for example, dicyclopentadiene), EPM rubbers (ethylene/propylene rubbers) and silicone rubbers, which optionally may likewise have a core/shell structure. Polybutadiene and alkyl acrylate rubbers are preferred.

The graft polymers contain 10 to 95% by weight, in particular 20 to 70% by weight, of rubber and 90 to 5% by weight, in particular 80 to 30% by weight, of graft-copolymerized monomers. The rubbers are present in these graft polymers in the form of at least partly crosslinked particles having a median particle diameter (d₅₀) of 0.05 to 20 μm, preferably of 0.1 to 2 μm and particularly preferably of 0.1 to 0.8 μm.

Such graft copolymers can be prepared by free radical graft copolymerization of monomers from the series consisting of styrene, α-methylstyrene, styrene substituted on the nucleus, (meth)acrylonitrile, methyl methacrylate, maleic anhydride, N-substituted maleimide, in the presence of the rubbers to be grafted. Preferred preparation processes for such graft copolymers are emulsion, solution, mass or suspension polymerization.

The thermoplastic copolymers can be synthesized from the graft monomers or similar monomers, in particular from at least one monomer from the series consisting of styrene, α-methylstyrene, halostyrene, acrylonitrile, methacrylonitrile, methyl methacrylate, maleic anhydride, vinyl acetate, N-substituted maleimide.

These are preferably copolymers of 95 to 50% by weight of styrene, α-methylstyrene, methyl methacrylate or mixtures thereof with 5 to 50% by weight of acrylonitrile, methacrylonitrile, methyl methacrylate, maleic anhydride, N-phenylmaleimide or mixtures thereof. Such copolymers also form as byproducts in the graft copolymerization. It is usual also to admix separately prepared copolymers in addition to the copolymers present in the graft polymer.

These need not be chemically identical to the ungrafted resin fractions present in the graft polymers. Suitable separately prepared copolymers are resinous, thermoplastic and rubber-free; they are in particular copolymers of styrene and/or α-methylstyrene with acrylonitrile, optionally as a mixture with methyl methacrylate.

Particularly preferred copolymers consist of 20 to 40% by weight of acrylonitrile and 80 to 60% by weight of styrene or α-methylstyrene. Such copolymers are known and can be prepared in particular by free radical polymerization, in particular by emulsion, suspension, solution or mass polymerization. The copolymers preferably have molecular weights M̅_{w} of 15 000 to 200 000.

The moulding materials according to the invention contain at least one ABS polymer and at least one metal oxide selected from oxides of the lanthanides in amounts of 0.01 to 1000 ppm, preferably of 0.1 to 100 ppm and particularly preferably of from 1 to 50 ppm (based in each case on ABS polymer).

In addition to the compounds to be used according to the invention, the moulding materials may contain customary additives, such as pigments, fillers, stabilizers, antistatic agents, lubricants, demoulding agents and flameproofing agents.

The invention also relates to a process for the preparation of the ABS polymer moulding materials according to the invention, containing at least one compound of the lanthanides.

For this purpose, 0.01 to 1000 ppm, preferably 0.1 to 100 ppm and particularly preferably 1 to 50 ppm (based in each case on ABS moulding material) of at least one compound of the lanthanides are added to at least one of the ABS polymers described above and mixing is effected at relatively high temperatures, in particular at 100° C. to 280° C., in customary mixing units, e.g. kneaders, internal mixers, roll mills, screw machines or extruders.

Depending on the intensity of the mixing, residence times of 10 seconds to 30 minutes may be required.

Alternatively, the mixing in the preparation of the ABS graft polymer by the emulsion polymerization process can also be effected by addition of an aqueous dispersion of the lanthanide compound component to the graft rubber latex and working up together.

### EXAMPLES

Polymers used:
A) Graft product consisting of 55% by weight of polybutadiene, having a median particle diameter (d₅₀) of 260 nm, onto which 32.85% by weight of styrene and 12.15% by weight of acrylonitrile were grafted.
B) Styrene/acrylonitrile (SAN)=72:28 copolymer having an average molecular weight (weight average) M̅_{w} of about 85 000 and a molecular nonuniformity M̅_{w}/ M̅ₙ−1 of ≦2.

Metal oxides used:

I) lanthanum oxide (La₂O₃), Acros

II) cerium oxide (CeO₂), Aldrich

III) tin oxide (SnO₂), comparative material, Sigma-Aldrich

### Examples 1 to 6

The amounts and types of metal oxides stated in Table 1 were mixed together with 30 parts by weight of graft product A), 70 parts by weight of SAN resin B), 0.15 part by weight of a silicone oil, 2 parts by weight of ethylenediaminebisstearylamide and 6.7 parts by weight of titanium dioxide (TiO₂) as a white pigment, at 180° C. to 200° C. in an internal kneader. The resulting mixture was granulated and, after mineralization with a sulphuric acid/nitric acid mixture, the content of metal oxide therein was determined by ICP-OES (measuring apparatus: Optima 3300 XL from Perkin Elmer).

As shown by the measured values in Table 1, the metal oxides of the lanthanides used are recovered with very high accuracy. Furthermore, there are no detectable disturbances by the presence of other metal oxides, in particular the titanium dioxide used as white pigment in large amount.

TABLE 1
Type and added amount of the metal oxides

| | Amount of | | | Amount of | | |
|---|---|---|---|---|---|---|
| | metal oxide used | | | metal oxide recovered | | |
| | La₂O₃ | CeO₂ | SnO₂ | La₂O₃ | CeO₂ | SnO₂ |
| Example | [ppm] | [ppm] | [ppm] | [ppm] | [ppm] | [ppm] |
| 1 | 10 | — | — | 9 | — | — |
| 2 | — | 10 | — | — | 8 | — |
| 3 | 10 | — | 20 | 9 | — | 13 |
| 4 | — | 10 | 20 | — | 10 | 13 |
| 5 | 10 | 10 | 20 | 9 | 9 | 13 |
| 6 | — | — | — | <1 | <1 | 3 |
| (comparison) | | | | | | |

### Examples 7 and 8

i) 0.005 part by weight of La₂O₃ and 100 parts by weight of graft product A) are homogeneously mixed in an internal kneader.
ii) 0.003 part by weight of CeO₂ and 100 parts by weight of SAN copolymer B) are homogeneously mixed in an internal kneader.

Thereafter, the mixtures present after i) and ii) in the ratio i):ii)=30:70 (Example 7) or i):ii)=50:50 (Example 8) are mixed analogously to Examples 1 to 6 in an internal kneader.

The measurement of the contents of metal oxides by the method described above gave 14 ppm of La₂O₃ and 20 ppm of CeO₂ for the product according to Example 7 and 23 ppm of La₂O₃ and 15 ppm of CeO₂ for the product according to Example 8.

Here too, the metal oxides are recovered with high accuracy.

1. ABS moulding materials containing an addition of at least one compound of the lanthanides.

2. ABS moulding materials according to claim 1, characterized in that at least one compound is an oxide.

3. ABS moulding materials according to claim 1, characterized in that they contain a combination of at least two different compounds of the lanthanides.

4. ABS moulding materials according to claim 1, characterized in that the compounds are selected from lanthanum oxide, cerium oxide, praseodymium oxide, neodymium oxide, samarium oxide, gadolinium oxide, dysprosium oxide, erbium oxide and ytterbium oxide.

5. ABS moulding materials according to claim 1, characterized in that the total amount of compounds of the lanthanides is 0.01 to 1000 ppm.

6. ABS moulding materials according to claim 1, characterized in that the total amount of compounds of the lanthanides is 0.1 to 100 ppm.

7. ABS moulding material according to claim 1, characterized in that it is present as a blend, in particular with polyamide, polycarbonate and/or polybutylene terephthalate.

8. Process for the preparation of ABS moulding materials according to claim 1, characterized in that 0.01 to 1000 ppm (based on ABS moulding material) of at least one compound of the lanthanides is added to an ABS polymer and thoroughly mixed at a temperature of 100° C. to 200° C.

9. Moulded body or granules obtainable from moulding materials according to claim 1.

10. Method for identifying ABS moulding materials, characterized in that at least one compound of the lanthanides is added to the moulding material the moulding material is optionally further processed and the amount of the lanthanides is spectroscopically analysed.
